(19) United States
(12) Patent Application Publication
(10) Pub. No.: US 2008/0239255 A1
(43) Pub. Date: Oct. 2, 2008

(54) Device and Method for Optically Detecting and Receiving Interconnected Sheets

(76) Inventors: Stephan Tratter, Wien (AT); Wolfgang Zagler, Wien (AT); Christoph Bauer, Oslip (AT); Markus Barth, Aigen (AT)

Correspondence Address: LADAS & PARRY LLP, 26 WEST 61ST STREET, NEW YORK, NY, 10023, US

(21) Appl. No.: 11/886,023

(22) PCT Filed: Apr. 5, 2006
(86) PCT No.: PCT/AT2006/000138

§ 371 Date: Jun. 5, 2008

(30) Foreign Application Priority Data
Apr. 5, 2005 (AT) A 575/2005

(51) Int. Cl. G03B 27/32

(52) U.S. Cl. 355/25

(57) ABSTRACT

The invention relates to a device and to a method for optically detecting and receiving, in particular for digitising, interconnected sheets (10) along a margin (6), in particular a book (7), comprising a bearing and/or securing device (8) for the sheets (10) and a receiving device (1) which comprises two angular imaging surfaces (2) which have a common vertex edge (3) and which are arranged in relation to each other, in addition to at least one receiving unit (19). The bearing and/or securing device (8) and the receiving device (1) are arranged in a displaceable manner in relation to each other, such that the vertex edge (3) of receiving device (1) and the margin (6) of the sheets (10) can be joined together. The receiving device (1) comprises traction means (15, 16) which are used to catch at least one sheet (10′) when removing the vertex edge (3) of the receiving device (1) from the margin (6) of the sheets (10).

The invention relates to a device for optically detecting and recording, in particular digitizing, leaves interconnected along a binding, in particular a book, including a supporting and fixing device respectively for the leaves and a recording device having two angularly arranged imaging surfaces with a common vertex edge as well as at least one recording unit, wherein the supporting and fixing device and the recording device are arranged in a relatively movable manner such that the vertex edge of the recording device and the binding of the leaves can be brought together, as well as a method for optically detecting and recording, in particular digitizing, leaves interconnected along a binding, in particular a book, wherein, for recording by the aid of a recording device including two angularly arranged imaging surfaces with a common vertex edge as well as at least one recording unit, the vertex edge of the recording device and the binding of the leaves are brought together and, for turning over, the vertex edge of the recording device is removed from the binding of the leaves.

In most cases, such devices and methods are referred to as so-called scanning devices and methods, respectively, this, however, implying a special type of recording. In the context of the present invention, any type of optical detection and recording, in particular for digitizing recorded images, may be provided, though.

Various devices for scanning unbound documents (single leaves), by which a scanning procedure can be realized in an extremely effective manner with low personnel expenditure, are already known.

The handling of bound works (books, pamphlets, brochures), however, involves considerably higher expenditures. Libraries and archives seeking to digitally capture (OCR or facsimile) their inventories or pass on books as copies (either printed on paper or in digital form) (e.g. instead of interlending the original or for making a second copy for the purpose of sparing the original) usually use incident-light book scanners, which require every single page to be manually opened under the camera, thus involving quite an amount of work and, in addition, the risk of considerable damage to the binding in many cases.

Besides for the systematic digitization in libraries and archives, devices for digitizing books, so-called book scanners, are also required by various service centers such as, for instance, universities, to convert teaching material into alternate formats (braille alphabet, synthetic language) for blind, motorically handicapped or dyslexic students. Finally, simple leaf turning devices are used today as aids for motorically disabled persons.

From EP 779 533 A1, a device and method of the initially defined kind for digitizing books are already known, wherein, however, an external means including several air outlets is provided for lifting and/or turning an uppermost leaf. There are introduced, at first, an air jet for separating the pages, then a further air jet for separating the uppermost pages from the remaining pages, and finally another air jet for pressing the uppermost pages against the imaging surfaces of an angularly shaped recording device for recording purposes. To achieve detachment from the imaging surfaces without causing damage to the pages, nozzles are additionally provided to enable air jets to be introduced between the recording device and the pages. The separation of an uppermost leaf from a bundle of leaves by the aid of an external means for introducing compressed air, thus, involves high structural expenditures and is, moreover, prone to failures.

From EP 779 534 A1, a device and method for digitizing books are, moreover, known, wherein the book to be digitized is positioned on a support comprising two supporting plates arranged to be movable relative to each other along a pivot axis. The recording device comprises two imaging surfaces arranged at an angle relative to each other, wherein, for the digitization of two book pages, the vertex edge of the two imaging surfaces is placed in the region of the binding, whereupon the supporting plates are pivoted in a manner that the pages to be digitized come to lie on the imaging surfaces. After the recording procedure, the linearly displaceable recording device is moved away from the book to be digitized; subsequently, a pick-up arm including vacuum outlets is moved to the page to be turned, and the turn-over procedure is performed by carrying out a pivotal movement of the pick-up arm. This has the drawback of involving not only a high structural expenditure but, in particular, also a relatively time-consuming recording procedure, since the recording device, at first, has to be removed from the leaves to be digitized before the turn-over procedure can be started.

From DE 38 08 429 A1, a device for digitizing a multi-leaf printed work is known, wherein a separate means for starting the turn-over procedure as is, for instance, known from paper counters is provided also there. Recording and/or digitization will only take place after the moved leaf has reached its end position. Thus, also that turning and recording procedure involves a high structural expenditure and is, moreover, time-consuming.

From DE 200 22 812 U1, another device for digitizing books is known, in which a lifting arm comprising a separate suction means is likewise provided to perform a pivotal movement for turning the pages of the book and separating the uppermost pages from the remaining book pages.

From WO 03/078176 A2, a page turning device for a book is known, in which a pivot arm comprising a suction means is again provided to vacuum-suck the book page to be turned and put it on the other side of the binding.

Furthermore, a device for digitizing books is known from U.S. Pat. No. 5,777,660 A, in which a recording device comprising two angularly arranged imaging surfaces sharing a common vertex edge is provided. To enable the turning of the pages, two horizontally and vertically displaceable supporting surfaces are provided, yet the way of how the individual pages of the book are actually turned is not explained in detail.

Finally, U.S. Pat. No. 4,633,080 A likewise discloses a device for digitizing books by the aid of a recording device having a vertex edge, wherein at least a surface adjoining the vertex edge comprises a transparent pane to which the page to be scanned is approached. The U.S. document, however, does not disclose how the uppermost leaves are turned and separated from the remaining leaves of the book.

Accordingly, it is the object of the present invention to provide a structurally simple device which, in a simple manner, enables, in particular, the turning or separation of an upper-most leaf or uppermost leaves of an opened book from the remaining leaves. Furthermore, a method is to be provided, in which a turn-over procedure is already initiated simultaneously with the relative movement between the recording device and the leaves to be recorded.

This is achieved by a device of the initially defined kind in that the recording device comprises attraction means for picking up at least one leaf during the removal of the vertex edge of the recording device from the binding of the leaves.

By providing attraction means for picking up at least one leaf of the bundle while the vertex edge and the binding are being removed from each other, it is, at the same time, feasible, during the removal of the vertex edge of the recording device from the binding of the leaves, to separate the picked-up leaf from the remaining leaves by the aid of the attraction means, thus initiating the turn-over procedure already in the course of this relative movement between the recording device and the bundle of leaves. Hence result not only a structurally simple device for separating the leaves from the remaining leaves of the bundle, but, in addition, also a rapid recording and turning device as compared to known devices, since the turn-over procedure is already initiated simultaneously with the relative movement between the recording device and the bundle of leaves to be detected. Advantageously, the whole recording procedure can be performed during that relative movement, since the leaves picked up by the attraction means will at least partially rest flatly on the imaging surfaces of the recording device. The attraction means may exert any attraction force on at least one leaf of the bundle to pick up the former, said force comprising, in particular, a suction force or even an electrostatic force.

If at least one opening for sucking at least one leaf is provided as said attraction means, a vacuum can be readily applied through this opening to suck at least an uppermost leaf of the bundle so as to be picked up by the recording device during the relative movement between the recording device and the binding of the leaves.

If at least one opening for sucking at least one leaf is provided in the region of the vertex edge of the imaging surfaces, one leaf will each be reliably detected on either side of the binding by the recording device upon application of a vacuum so as to enable, during the relative movement between the recording device and the binding of the leaves, the digitization of the leaves resting against the recording device at least in this partial region.

In order to reliable keep the sucked, uppermost leaves of the bundle of leaves in a position resting on the imaging surfaces during the relative movement between the recording device and the binding of the leaves, it is beneficial if further openings distributedly arranged on the imaging surfaces are provided for sucking at least one leaf.

With regard to a structurally simple, suitable relative movement between the recording device and the bundle of leaves, it is advantageous if the recording device is driven so as to be linearly displaceable.

If the supporting and fixing device comprises two angularly arranged plates preferably enclosing an angle of between 50 and 110°, the recording device will be reliable moved to the binding of the leaves by its vertex edge; in an advantageous manner, the bundle of leaves, thus, need not be opened into an opening position enclosing an angle of 180°, which would frequently cause damage to the binding of a book.

In order to enable also loose leaves to be digitized by the device according to the invention, it will be favorable if the plates are associated with a clamping means for clamping loose leaves, which, in the clamped state, are guided through a slot formed between the two plates.

If the the supporting and fixing device is fastened to a carriage capable of being displaced perpendicularly to the moving direction of the recording device, this will enable the self-adjustment of the supporting and fixing device during the approach of the vertex edge of the recording device to the binding of the leaves, so that the linearly displaceable recording device will be reliably brought together with the binding of the leaves by its vertex edge.

If the the recording device comprises a substantially closed housing whose wall surfaces are at least partially formed by the imaging surfaces, wherein at least one connection opening is provided for a suction or pressure line, it will be feasible in a simple manner to generate a vacuum for sucking the leaves to be recorded; it is likewise feasible in a simple manner to create an overpressure during the approach of the vertex edge of the recording device to the binding, in order to ensure that the leaves will lie planely one above the other.

In case several leaves of the binding are sucked by the air openings, it is beneficial if at least one pivotable flap including an air opening is each provided in lateral wall surfaces of the housing. It will, thus, be feasible to separate the already detected leaves resting on the imaging surfaces from the remaining sucked leaves by an inward pivotal movement of said flaps so as to solely ensure the turning of already detected leaves.

For the detection and recording of the leaves, it is favorable if at least one digital and/or line camera is provided as said recording device.

In order to achieve a particularly high picture quality while, at the same time, keeping the number of digital cameras relatively small, it is advantageous if an optical glass prism is each provided on either side of the vertex edge, wherein both said glass prisms are associated with a single row of digital cameras for digitizing the images deflected in the glass prisms. In addition, the glass prisms immediately adjoining the vertex edge will also reliably ensure the recording of books having very low webs of up to about 3 mm.

In order to enable the taking of a picture simultaneously on both imaging surfaces, it is, however, also feasible in an alternative manner that a digital camera is each associated with either of the two imaging surfaces. If several digital cameras are associated with each of the imaging surfaces, it will be feasible to achieve a higher recording quality per imaging surface than with just one digital camera while, at the same time, also keeping costs relatively low.

In this respect, it is, on the one hand, possible that the recording fields of the digital cameras each cover an entire imaging surface wherein the digital camera and, in particular, 3 or 4 digital cameras are arranged with slightly overlapping recording fields. The overlapping arrangement of the recording fields enables the digitized images to be subsequently composed to an overall picture in a simple manner (by so-called stitching). Alternatively, it is also feasible for the recording fields of the digital cameras to not cover all of the imaging surface, but provide air openings in the imaging surface sections located between the imaging fields. In doing so, the data streams obtained will be substantially smaller, since only partial recordings are made. Besides, the digital cameras have sufficient time to process and store the recorded data before a new working step will be started.

Alternatively to the previously mentioned digital cameras, it is also feasible to provide at least one recording bar comprised of CIS (compact image sensor) or CCD (charge-coupled device) modules as said recording device. A CIS module in this context is a combination of a CMOS (complementary metal oxide semiconductor) sensor series, a linear optics and a LED lighting. CCD modules are semiconductor components which, in a manner similar to the human retina, consist of a plurality of light-sensitive cells. The cells convert the light into electric charge, which will be read out as a digital value. This multitude of cells produces a digital raster image. The higher the number of cells (resolution), the finer the image.

The method of the initially defined kind is characterized in that at least one leaf is picked up by an attraction force via the recording device such that, during the removal of the vertex edge of the recording device from the binding of the leaves, at least one leaf is separated from the remaining leaves. As already described in connection with the previously explained device, the application of an attraction force, e.g. a suction force or an electrostatic force, allows for the simultaneous initiation of the turn-over procedure already during the removal of the recording device from the binding of the leaves, by separating at least an uppermost leaf from the remaining leaves, so that the bundled leaves will be detected and recorded in a particularly simple and rapid manner. To avoid repetitions, it is referred to previous statements concerning further advantages.

In order to provide a reliable control of the attraction force with a view to possibly avoiding several leaves from being picked up from one side of the binding during the removal of the recording device from the binding of the leaves, it is favorable if the leaf is sucked during the removal of the vertex edge of the recording device from the binding of the leaves.

In order to enable the simultaneous detection and recording of two leaves arranged on either side of the binding during the removal of the vertex edge of the recording device from the binding of the leaves, it is beneficial if one leaf is each separated from the remaining leaves on either side of the binding during the the removal of the vertex edge of the recording device from the binding of the leaves.

For the purpose of providing a recording procedure as rapid and efficient as possible, it is favorable if, during the the removal of the vertex edge of the recording device from the binding of the leaves, the picked-up leaves are optically detected and recorded, in particular digitized.

In order to enable the simple turning of the leaves separated by the aid of the recording device such that leaves not yet detected will come to lie on top of the bundle, it is beneficial if the separated leaves are collectively placed on one side of the binding by an air blast. Alternatively, a pivotable turning arm may, however, be provided for turning the leaves already separated from the remaining leaves.

If, during the approach of the vertex edge of the recording device to the binding of the leaves, an air stream is ejected from holes provided in the imaging surfaces, it will be reliably ensured by the blown-out air that the uppermost leaves of the bundle will lie planely so as to avoid both damage to them and irregularities during the recording procedure due to the possible formation of creases.

In the following, the invention will be explained in more detail by way of preferred exemplary embodiments illustrated in the drawing, to which it is, however, not to be restricted. In detail, in the drawing:

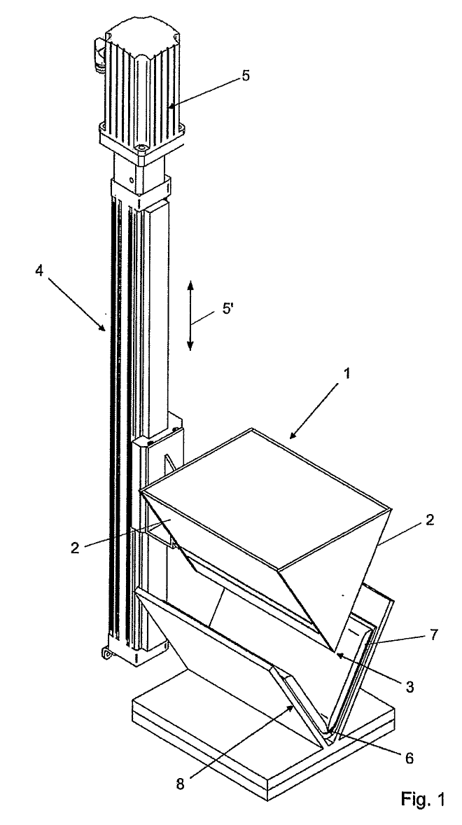

FIG. 1 is a schematically perspective view of a recording device including a linear drive unit;

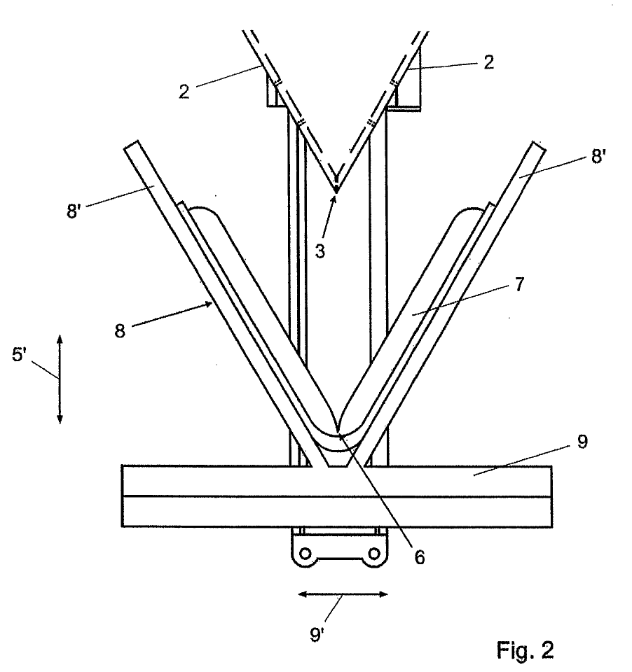

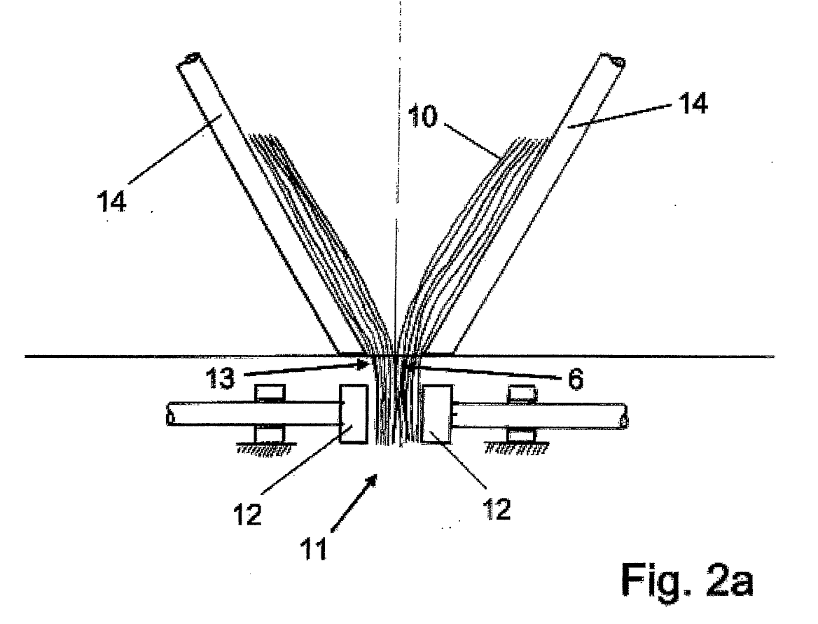

FIG. 2 shows a detail of a book supporting device;

FIG. 2a shows a detail of a clamping device for bundling loose leaves;

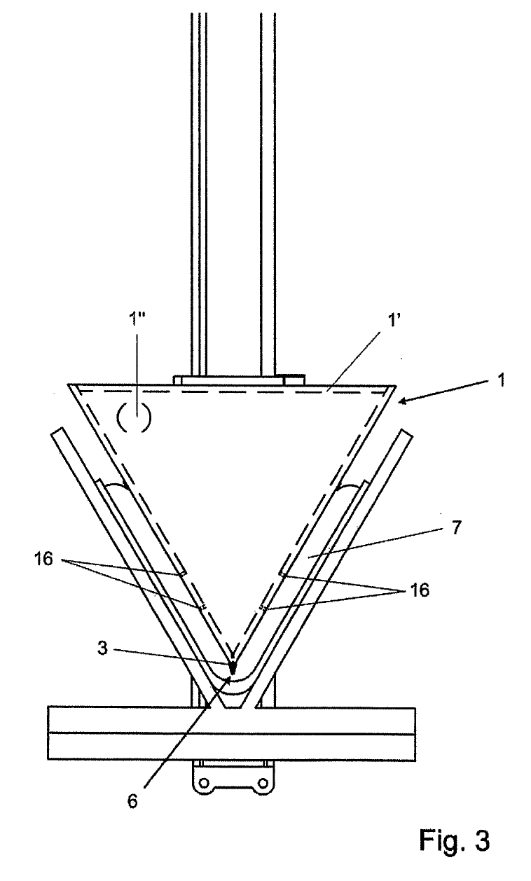

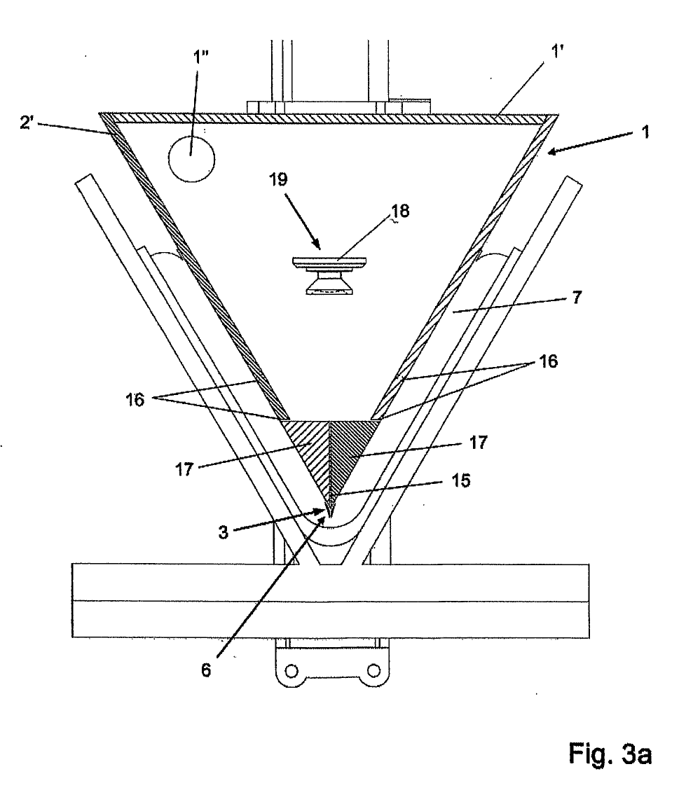

FIG. 3 is a view in which a vertex edge of the angular recording device and a binding of a book to be digitized have been brought together;

FIG. 3a is a partially broken view according to FIG. 3;

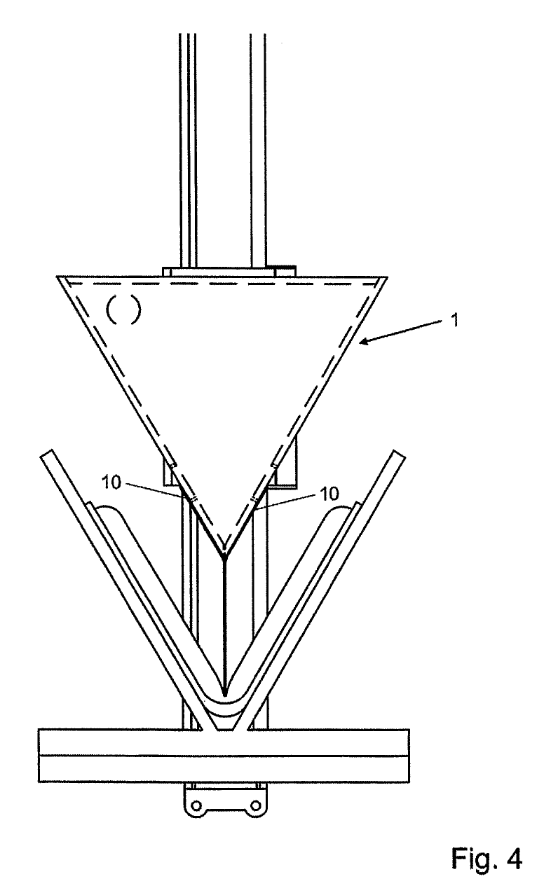

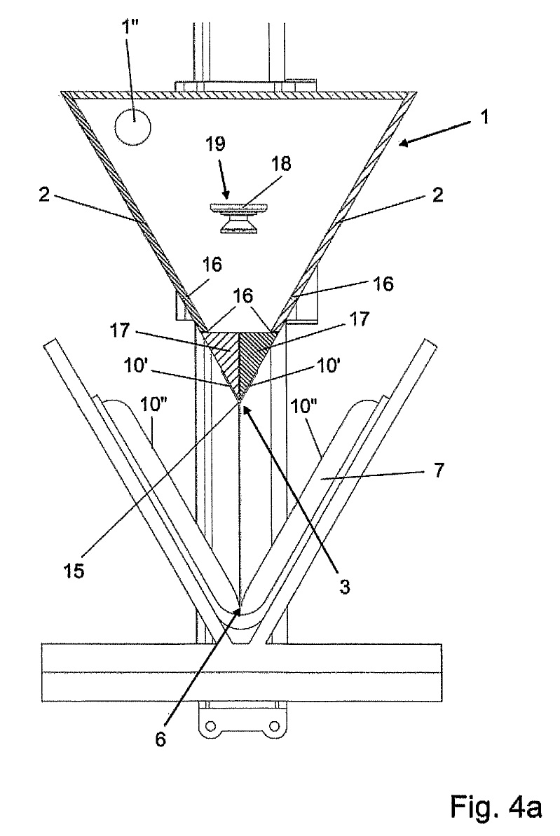

FIG. 4 is a view during the removal of the recording device from the binding of the leaves;

FIG. 4a is a partially broken view according to FIG. 4;

FIG. 5 is a partially broken, perspective view according to FIGS. 4 and 4a;

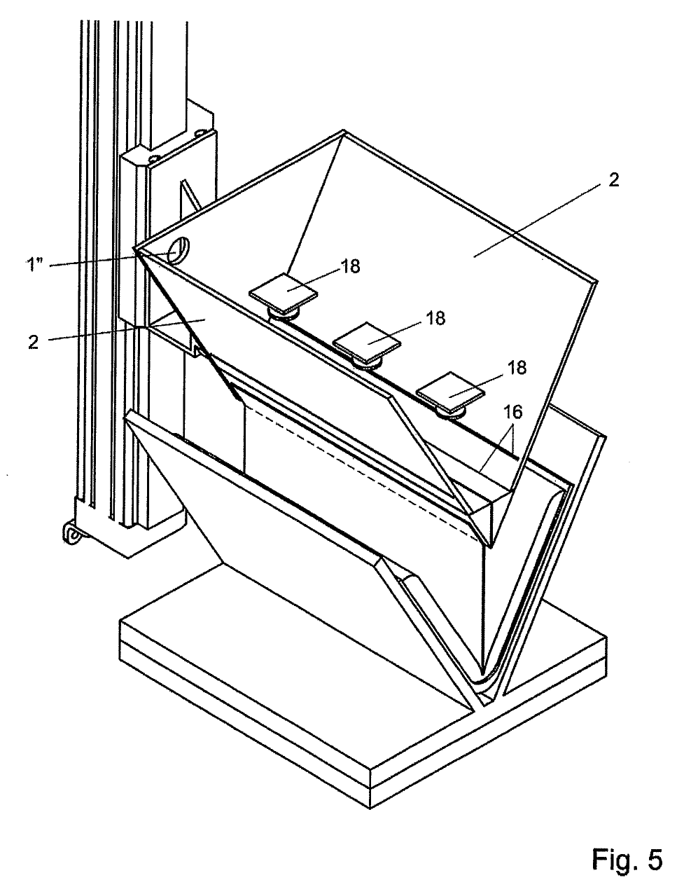

FIG. 6 is a side view of the recording device;

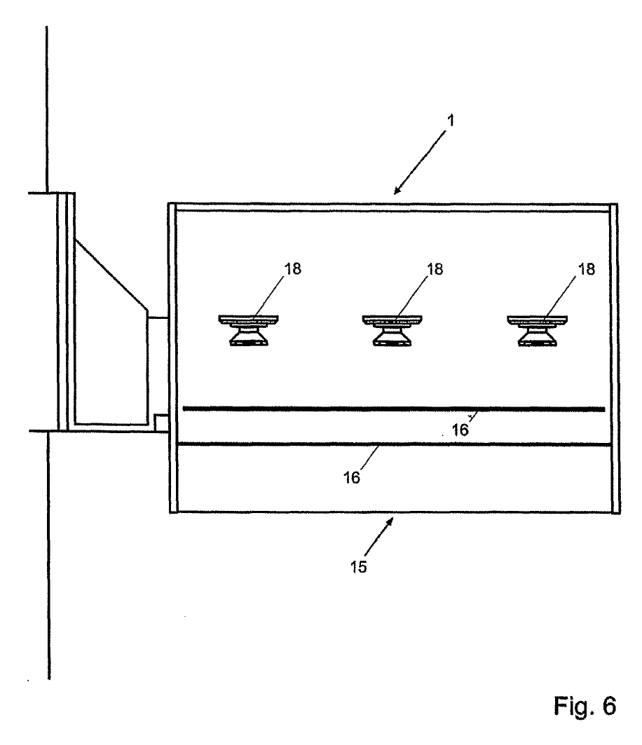

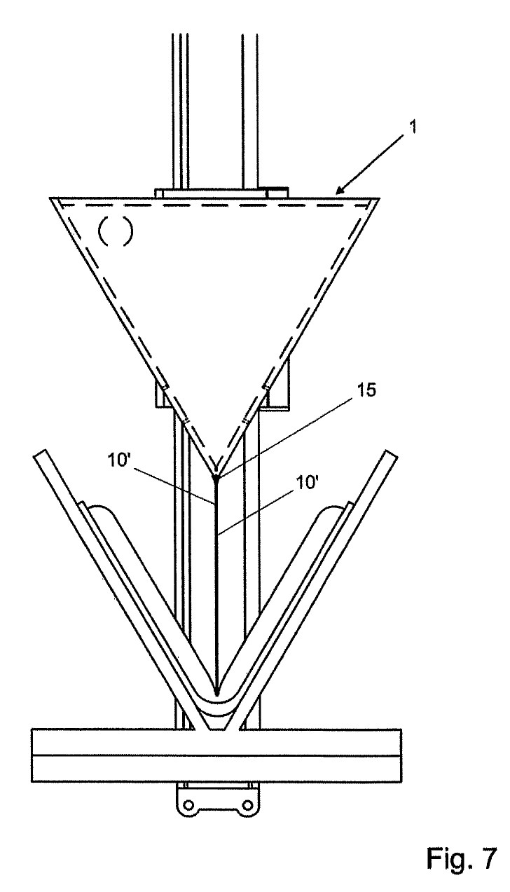

FIG. 7 is a further view of the recording device during its upward movement shortly before loosing contact with the sucked leaves;

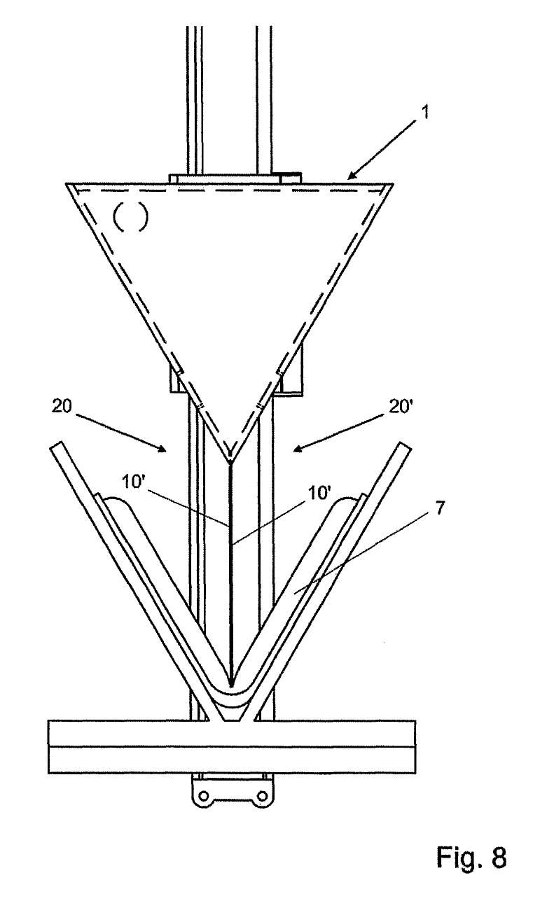

FIG. 8 is a view after two leaves of a book have been separated and an air blast has been introduced for reversing the leaves;

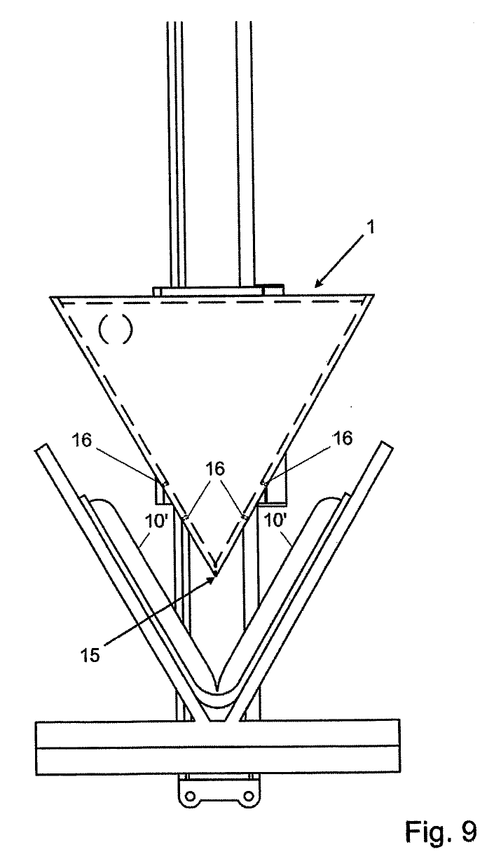

FIG. 9 is a view during the approach of the recording device to the book;

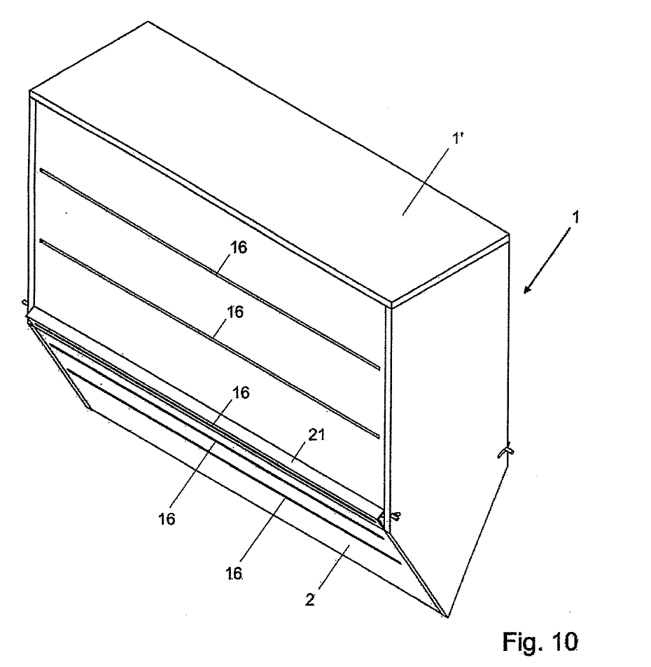

FIG. 10 is a perspective view of a recording device including pivotable flaps;

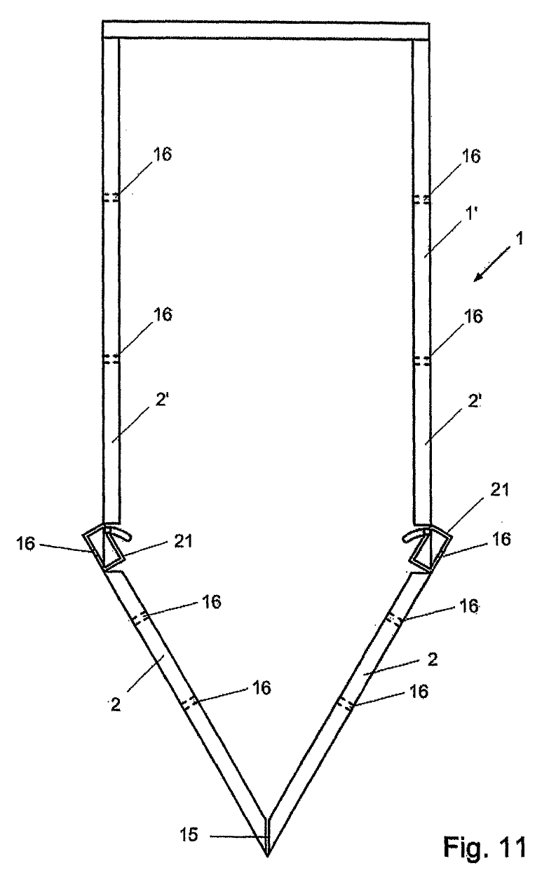

FIG. 11 is a view of the recording device according to FIG. 10 with the front wall face removed; and

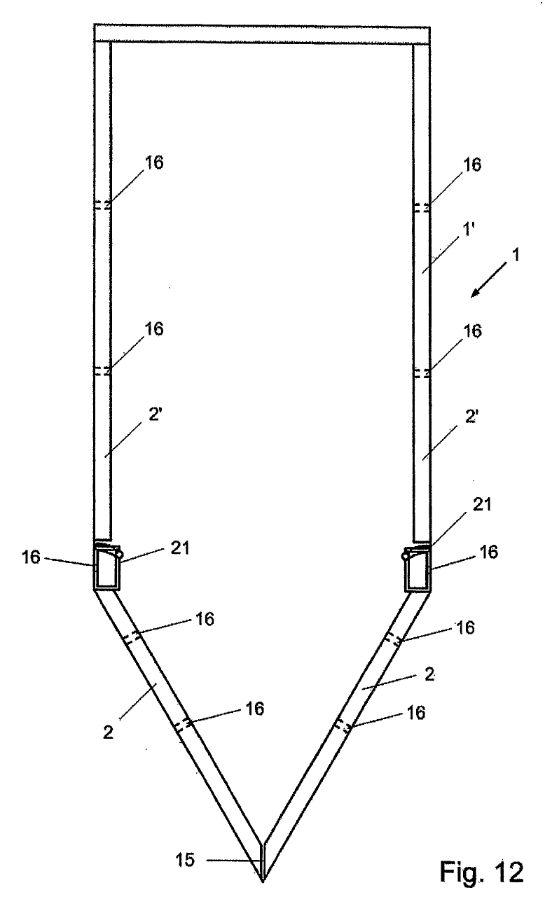

FIG. 12 is a view of the recording device according to FIG. 11 with the flaps pivoted in.

FIG. 1 depicts a recording device 1 comprising two imaging surfaces 2 arranged at an angle relative to each other and having a common vertex edge 3.

The recording device 1 is mounted on a linear unit 4, on which it is arranged so as to be displaceable by a drive motor 5. The recording device 1 by its vertex edge 3 can, thus, be approached to a binding 6 of a book 7, and moved away from the binding 6, by the aid of the drive motor 5.

As is particularly apparent from FIG. 2, the book 7 rests on an angular supporting means 8 comprising two plates 8′ which are mounted so as to be displaceable, by the aid of a carriage 9, perpendicularly to the moving direction 5′ of the linear unit 5 on the carriage 9 in the sense of arrow 9′. The opening angle of the supporting means 8 may be adjusted between about 50 and 110° as a function of the book to be digitized, whereby, however, by the aid of the horizontally displaceable carriage 9, the vertex edge 3 of the recording device 1 will reliably come into abutment in the region of the binding 6 during the digitizing procedure without any external adjustment.

As is apparent from FIG. 2a, even loose sheets 10 can be digitized by the device according to the invention, in which case these will be connected with one another along a binding 6 by means of two clamping jaws 12 in the clamping means 11 illustrated in FIG. 2a and conducted through a passage opening 13 of two plates 14 provided as supports, so that the loose sheets 10 will be present in the clamping device 11 in the manner of a bound book.

FIG. 3 depicts the recording device 1 in detail in its lowermost position, in which the vertex edge 3 of the substantially prism-shaped recording device 1 rests substantially on the binding 6 of the book 7 to be digitized. From the corresponding view of FIG. 3a, in which, however, the recording device 1 is illustrated in section, it is, in particular, apparent that the recording device 1, in the region of the vertex edge 3, comprises an air opening 15 substantially extending over the total length of the vertex edge 3 and adjacent to which are the imaging surfaces 2. Such a continuous air slot may, of course, also be replaced with a plurality of small air openings.

It is additionally apparent from FIG. 3a that a glass prism 17 is each arranged adjacent the air opening 15 extending along the vertex edge 3. These cut glass prisms 17 each serve to project a strip of an uppermost leaf 10′ (cf. FIG. 4) into the interior of the recording device 1 in a distortion-free manner. Between the two glass prisms 17 remains, however, a gap through which air sucked in through the air opening 15 in the region of the vertex edge 3 can pass.

As is further apparent from FIG. 3a and, in particular, FIGS. 5 and 6, the two optical glass prisms 17 are associated with a single row of digital cameras 18 forming a recording unit 19 to simultaneously record the two projections on the upper surfaces of the glass prisms 17. Since only relatively narrow image information strips are, thus, recorded from the uppermost leaves 10′, image processing is comparatively simple with the two strips from the taken images being isolated and stored using the appropriate software.

The recording fields of the digital cameras 18 in this case partially overlap one another such that the partial images will then be composed by the appropriate software (stitching) to a page to be processed further. Digitization in this exemplary embodiment, thus, takes place during the ongoing turn-over procedure, i.e. during the upward movement of the recording device 1. In doing so, the digital cameras 18 stepwisely take pictures of the images projected by the optical prisms 17 and pass them on to a computer for processing. Due to the optical projection by the aid of the glass prisms 17, a comparatively high picture quality of about 600 to 1,200 dpi can, thus, be achieved by a single row of digital cameras 18. In addition, the glass prisms 17 may immediately adjoin the air opening 15 in the region of the vertex edge 3 of the recording device 1, as is particularly apparent from FIG. 3a, so as to enable the uppermost leaves 10′ of the book 7 to be already digitized at a very small distance of about 3 mm from the binding. The lateral wall surfaces 2′ of the imaging surfaces 2 adjoining the glass prisms may, for instance, be made of glass or synthetic material.

Further air openings 16 are provided in the lateral wall surfaces 2′ to reliable hold the sucked, uppermost leaves 10′ of the book 7 in a position abutting on the glass prisms 17 during the upward of the recording device 1.

Still another opening 1″, moreover, is to be seen in the back wall of the recording device 1, which is substantially formed as a closed housing 1′, to which opening a suction or pressure line may be connected for introducing and/or sucking of an air stream.

FIGS. 4 and 4a depict the recording device 1 in an upwardly moved position as compared to FIG. 3, wherein it is apparent that the uppermost leaves 10′ of the book 7 are separated from the remaining leaves 10″ of the book 7 during the upward movement of the recording device 1, by the aid of the air opening 15 arranged in the region of the vertex edge and/or the air openings 16 provided in the imaging surfaces 2 so as to initiate the turn-over procedure already simultaneously with the upward movement of the recording device, thus substantially reducing the time expenditure involved in the digitization of the book 7 as compared to known devices and methods.

In FIG. 7, the recording device 1 is shown in a further upwardly moved position, with the uppermost leaves 10′ of the book being still sucked against the imaging surfaces 2 of the recording device 1 via the air opening 15 provided in the region of the vertex edge 3.

As is apparent from FIG. 8, the sucked leaves 10′ are detached from the recording device 1 during the further upward movement of the recording device 1 such that the air openings 15 will be exposed. By the sudden drop of the suction pressure, the control device readily recognizes that the leaves 10′ have been released, thus completing the turn-over procedure by introducing a lateral air stream in the sense of arrow 20 or 20′ to place the then digitized leaves 10′ into the desired direction, to which end air outlet openings may, for instance, be provided in the freely cantilevering end regions of the plates 8′. Alternatively to the recognition on grounds of the sudden pressure drop, the control device may also be activated upon recognition of an upper white margin, or instead of introducing a lateral air stream it is also feasible to provide a mechanical reversing finger.

FIG. 9 illustrates the introduction of a further turn-over and digitizing procedure, wherein an air stream is in this case blown out via the air openings 16 during the approach of the vertex edge 3 of the recording device 1 to the binding 6 of the book 7 so as to ensure, during the downward movement of the recoding device 1, that the uppermost leaves 10′ of the book 7 lie planely on the remaining leaves 10″. In this case, it will be favorable if the air stream is the strongest in the region of the vertex edge 3 of the recording device 1 and decreases continuously towards the outer edge of the imaging surfaces 2.

FIGS. 10 to 12 illustrate an alternative exemplary embodiment of the recording device 1, in which the housing 1′ comprises wall or imaging surfaces 2 obliquely arranged relative to each other and adjoined by parallelly extending wall surfaces 2′. Between the two wall surfaces 2, 2′ are arranged pivotable flaps 21 including air openings 16. In the position of the recording device 1 placed on the binding 3, the flaps 21 are at first arranged in their outwardly pivoted positions shown in FIG. 11. If, however, more than a respectively uppermost leaf 10′ of the bundle of leaves is sucked by the air openings 15, 16, the pivoting of the flaps 21 into the position shown in FIG. 12 will reliably cause just a single leaf 10′ to be each held against the recording device 1 so as to allow the remaining sucked leaves to be readily separated from the uppermost leaves 10′ to be digitized. No recording device is shown in FIGS. 10 to 12, yet also here the respective recording device 19 is, of course, to be provided for digitizing the leaves 10′.

Alternatively to the above-described recording unit 19, it is also feasible to provide only two highly resolving digital cameras whose recording fields each correspond precisely to an imaging surface 2. The imaging surfaces 2 in this case are made of light-permeable materials, e.g. break-proof glass acrylic or polycarbonate. Digital cameras of this type may be positioned at different distances from the imaging surfaces such the resolution of the digital recordings can be adapted to the sizes of the sheets.

Furthermore, it is alternatively possible to each associate an array of, for instance, 3×3 or 4×3 digital cameras 18 with a single imaging surface 2.

Since in the previously mentioned cases the total imaging surfaces 2 are detected by the recording fields of the digital cameras 18, the whole page of a book can already be digitized in the lowermost position of the recording device 1, and the detected data can be processed during the upward movement of the recording device 1, which will, at the same time, initiate the turn-over procedure.

It is, however, also conceivable that only a small number of digital camera modules comprising about three to four digital cameras per module are each associated with an imaging surface 2. In this case, only one strip of the leaf 10′ to be digitized will each be initially recorded in a lowermost starting position of the recording device 1, and a further strip will be detected by the digital cameras 18 upon lifting of the recording device 1. These strip-shaped image sections will then again be composed to an overall picture by the appropriate software (a stitching program). In doing so, it is advantageous that it is unnecessary to cover the complete imaging surface by the recording fields of the digital cameras 18 in order to achieve a high resolution, and that, in addition, the data streams are substantially smaller, since only partial recordings are made. Besides, the digital cameras 18 have sufficient time to process and store the recorded data before the next operating step will take place.

It goes without saying that the digital cameras 18 may be replaced with other devices for digitizing the leaves, such as, for instance, digitizing bars comprised of CIS (compact image sensor) or CCD (charge-coupled device) modules. Even the use of conventional scanning devices may be envisaged.

Furthermore, the supporting and fixing device 8 of the book may just constitute a part of a book battery so as to enable further books to be automatically subjected to a digitizing procedure upon completion of the digitization of a first book 7 by the aid of the book battery.

Another advantageous effect of the suction of the uppermost leaves 10′ of a bundle consists in that the sucked leaves 10′ will wipe the imaging surfaces 2 during the upward movement of the recording device 1 so as to automatically clean the imaging surfaces 2. And due to the passage of an air stream for sucking the leaves, the components arranged in the recording device 1, e.g. the recording unit 19, will be permanently cooled by the air stream passed therethrough.

1. A device for optically detecting and recording, in particular digitizing, leaves (10) interconnected along a binding (6), in particular a book (7), including a supporting and fixing device (8) respectively for the leaves (10) and a recording device (1) having two angularly arranged imaging surfaces (2) with a common vertex edge (3) as well as at least one recording unit (19), wherein the supporting and fixing device (8) and the recording device (1) are arranged in a relatively movable manner such that the vertex edge (3) of the recording device (1) and the binding (6) of the leaves (10) can be brought together, characterized in that the recording device (1) comprises attraction means (15, 16) for picking up at least one leaf (10′) during the removal of the vertex edge (3) of the recording device (1) from the binding (6) of the leaves (10).

2. A device according to claim 1, characterized in that at least one opening (15, 16) for sucking at least one leaf (10′) is provided as said attraction means.

3. A device according to claim 2, characterized in that at least one opening (15) for sucking at least one leaf (10′) is arranged in the region of the vertex edges (3) of the imaging surfaces (2).

4. A device according to claim 2, characterized in that openings (16) distributedly arranged on the imaging surfaces (2) are provided for sucking at least one leaf (10′).

5. A device according to claims 1, characterized in that the recording device (1) is driven so as to be linearly displaceable.

6. A device according to claims 1, characterized in that the supporting and fixing device (8) comprises two angularly arranged plates (8′, 14) preferably enclosing an angle of between 50 and 110°.

7. A device according to claim 6, characterized in that the plates are associated with a clamping means (11) for clamping loose leaves (10), which, in the clamped state, are guided through a slot (13) formed between the two plates (14).

8. A device according to claims 5, characterized in that the supporting and fixing device (8) is fastened to a carriage (9) capable of being displaced perpendicularly to the moving direction (5′) of the recording device (1).

9. A device according to claims 1, characterized in that the recording device (1) comprises a substantially closed housing (1′) whose wall surfaces (2′) are at least partially formed by the imaging surfaces (2), wherein at least one connection opening (1″) is provided for a suction or pressure line.

10. A device according to claim 9, characterized in that at least one pivotable flap (21) including an air opening (16) is each provided in lateral wall surfaces (2, 2′) of the housing (1).

11. A device according to claims 1, characterized in that at least one digital and/or line camera (18) is provided as said recording unit (19).

12. A device according to claim 11, characterized in that an optical glass prism (17) is each provided on either side of the vertex edge (3), wherein both said glass prisms (17) are associated with a single row of digital cameras (18) for digitizing the images deflected in the glass prisms (17).

13. A method for optically detecting and recording, in particular digitizing, leaves (10) interconnected along a binding (6), in particular a book (7), wherein, for digitizing by the aid of a recording device (1) including two angularly arranged imaging surfaces (2) with a common vertex edge (3) as well as at least one recording unit (19), the vertex edge (3) of the recording device (1) and the binding (6) of the leaves (10) are brought together and, for turning over, the vertex edge (3) of the recording device (1) is removed from the binding (6) of the leaves (10), characterized in that at least one leaf (10′) is picked up by an attraction force via the recording device (1) such that, during the removal of the vertex edge (3) of the recording device (1) from the binding (6) of the leaves (10), at least one leaf (10′) is separated from the remaining leaves (10″).

14. A method according to claim 13, characterized in that the leaf (10′) is sucked during the removal of the vertex edge (3) of the recording device (1) from the binding (6) of the leaves (10).

15. A method according to claim 13, characterized in that one leaf (10′) is each separated from the remaining leaves (10″) on either side of the binding (6) during the removal of the vertex edge (3) of the recording device (1) from the binding (6) of the leaves (10).

16. A method according to claim 15, characterized in that, during the removal of the vertex edge (3) of the recording device (1) from the binding (6) of the leaves (10), the picked-up leaves (10′) are optically detected and recorded, in particular digitized.

17. A method according to claim 15, characterized in that the separated leaves (10′) are collectively placed on one side of the binding (6) by an air blast (20, 20′).

18. A method according to claim 13, characterized in that, during the approach of the vertex edge (3) of the recording device (1) to the binding (6) of the leaves (10), an air blast is ejected from holes (15, 16) provided in the imaging surfaces (2).
